(19) United States
(12) Patent Application Publication
(10) Pub. No.: US 2007/0206889 A1
(43) Pub. Date: Sep. 6, 2007

(54) Fluid Dynamic Pressure Bearing, Spindle Motor Provided with the Fluid Dynamic Pressure Bearing, and Recording Disk Drive Device Provided with the Fluid Dynamic Pressure bearing

(75) Inventors: Rikuro Obara, Kitasaku-Gun (JP); Tadashi Akahori, Kitasaku-Gun (JP)

Correspondence Address: OLIFF & BERRIDGE, PLC, P.O. BOX 19928, ALEXANDRIA, VA, 22320, US

(73) Assignee: Minebea Co.,Ltd, Nagano-Ken (JP)

(21) Appl. No.: 11/629,900

(22) PCT Filed: Jul. 19, 2005
(86) PCT No.: PCT/IB05/02071

§ 371 Date: Jan. 19, 2007

(30) Foreign Application Priority Data
Jul. 28, 2004 (JP) 2004-220807
May 31, 2005 (JP) 2005-160678

(51) Int. Cl. F16C 32/06

(52) U.S. Cl. 384/100

(57) ABSTRACT

A fluid dynamic pressure bearing is constituted in which a shaft member, including thrust plates 5 engaged with small-diameter portions at both ends of a shaft 1, is relatively rotatably combined with a bearing member via radial and axial dynamic pressure bearings. The bearing member includes a casing 3, a sleeve assembly body engaged to the casing 3, and seal rings 6 engaged to end portions of the casing 3. The sleeve assembly body is constituted by two or more sleeve elements 2 and a spacer sleeve element 4 coaxial with and sandwiched between the sleeve elements 2. Capillary seal portions 9 are formed between the thrust plates 5 and the seal rings 6. Highly accurate finishing of the dynamic pressure bearing portions, capillary seal portions, etc. can easily be accomplished by an easy, highly accurate processing, even if the shaft member or bearing member of a spindle motor becomes longer as a memory capacity of a memory device is increased.

### BACKGROUND

This invention relates to a fluid dynamic pressure bearing, and particularly to a fluid dynamic pressure bearing used for a bearing of a spindle motor in a memory device in which an information storage medium such as a magnetic disk or an optical disk is mounted. The fluid dynamic pressure bearing can increase the number of disks able to be mounted, in order to enlarge memory capacity of the memory device. This invention also relates to a spindle motor and a recording disk drive device that are provided with the fluid dynamic pressure bearing.

Recently, in computer memory devices in which information storage media such as magnetic disks or optical disks are mounted, there is a strong demand for higher density, miniaturization, thinness, and lightness. Because of this, there is a strong demand for increasing the rpm (revolutions per minute) and improving rotation precision of a spindle motor used for disk rotation.

In order to respond to these demands, instead of conventional ball bearings, fluid dynamic pressure bearings have been widely used as rotation bearings. Meanwhile, larger memory capacities are being achieved by increasing the number of disks mounted.

The more the number of disks, the longer the axial length of the spindle motor becomes and the heavier the weight becomes. Furthermore, very precise rotation needs to be maintained and productivity also needs to be maintained, resulting in many problems that appear as new conditions placed on the fluid dynamic pressure bearing.

FIG. 7 shows an example (first conventional example) of a conventional fluid dynamic pressure bearing. The fluid dynamic pressure bearing 00 includes a fixed shaft member. The fixed shaft member includes a fixed shaft 01 having a large-diameter portion of length L1 at an intermediate portion of the fixed shaft, and having small-diameter portions at both end portions of the fixed shaft. The fixed shaft member also includes thrust plates 05, 05 that are engaged to the small-diameter portions.

The fluid dynamic pressure bearing 00 also includes a sleeve 02 with an overall length L and a straight outer circumferential surface. The sleeve 02 has a thick portion of length L2 at an axially central portion of the sleeve 02, thin portions at both end portions of the sleeve 02, and intermediate thickness portions between the thick portion and each thin portion. The sleeve 02 is supported by the fixed shaft member via micro gaps that are respectively formed between the inner circumferential surface of the thick portion of the sleeve 02 and an outer circumferential surface of the large-diameter portion of the fixed shaft 01, and between both end surfaces of the thick portion of the sleeve 02 and the inner end surfaces of the thrust plates 05, 05. Seal rings 06, 06 are engaged with step portions formed at transitions between the intermediate thickness portions and the thin portions. Both step portions are formed in the same shape. The length between the end surface of one of the intermediate thickness portions and the end surface of the other intermediate thickness portion (length between both step portions) is set at L3.

In the sleeve 02, one or more through holes 07 are formed, extending in the axial direction of the sleeve 02 and spaced apart in the circumferential direction of the sleeve 02. These through holes 07 provide fluid communication between a micro gap formed between one end surface of the thick portion of the sleeve 02 and the inner end surface of one thrust plate 05, and a micro gap formed between the other end surface of the thick portion and the inner end surface of the other thrust plate 05. Therefore, lubricant that fills these micro gaps is in fluid communication with lubricant that fills the through holes 07.

Various micro gaps within the fluid dynamic pressure bearing 00 are in fluid communication with each other. Specifically, (1) micro gap formed between the thick portion inner circumferential surface of the sleeve 02 and the large-diameter portion outer circumferential surface of the fixed shaft 01; (2) micro gaps formed between both end surfaces of the thick portion of the sleeve 02 and the inner end surfaces of the thrust plates 05, 05; (3) micro gaps formed between the intermediate thickness portion inner circumferential surfaces of the sleeve 02 and the outer circumferential surface of the thrust plates 05; and (4) micro gaps formed between the inner end surface of the seal rings 06 and the outer end surface of the thrust plates 05 are in fluid communication with each other. Lubricant 010 fills the communicating micro gaps. A continuous oil film of the lubricant 010 is provided in the micro gaps. The continuous oil film is in a substantially cylindrical shape and has a uniquely shaped cross section, open at both ends, and both end portions of the continuous oil film protrude inward toward the fixed shaft 01.

Both end portions of the continuous oil film of the lubricant 010 overflow into cross-sectionally wedge-shaped micro gaps formed by a flat outer end surface of the thrust plates 05 and an inner end surface of the seal rings 06 that tapers outward as it approaches the center. The end portions of the continuous oil film are contained in these micro gaps. Due to capillarity, a force constantly draws the continuous oil film into the continuous micro gaps. Additionally, each end portion of the continuous oil film forms a liquid surface (meniscus) due to surface tension. Thus, both end portions of the oil film are sealed so that the lubricant 010 does not leak out. Thus, the oil storage portions formed by the cross-sectionally wedge-shaped micro gaps form capillary seal portions with respect to the lubricant 010.

On the thick portion inner circumferential surface of the sleeve 02, two radial dynamic pressure generating grooves 02-1 are formed which are spaced apart in the axial direction of the sleeve 02. On both thick portion end surfaces of the sleeve 02 facing the inner end surfaces of the thrust plates 05, 05, axial dynamic pressure generating grooves 02-2 are formed. Therefore, when the bearing member is rotated, the bearing member is floatingly supported by a radial dynamic pressure force and an axial dynamic pressure force generated within the lubricant 010 filled in the micro gaps facing the radial dynamic pressure generating grooves 02-1 and the axial dynamic pressure generating grooves 02-2 of the sleeve 02, and rotates without contacting the fixed shaft member.

FIG. 8 shows another example (second conventional example) of a conventional fluid dynamic pressure bearing. Compared to the first conventional example, the second conventional example is basically different from the first conventional example because the sleeve 02 is divided into two members. That is, in this second conventional example, the intermediate thickness portion and thin portion of the sleeve 02 of the first conventional example, including a portion of the thick portion that has a thickness the same as that of the intermediate thickness portion, are separated from the sleeve 02 of the first conventional example and a new casing 03 is formed. The remaining portion of the thick portion becomes a new sleeve 02. Thus, because of the division of the sleeve 02 of the first conventional example into two members, the newly formed sleeve 02 needs to be engaged to the newly formed casing 03. For this engagement, a method is used in which adhesive 08 is inserted into a circumferential groove 03-4 arranged on the inner circumferential surface of the casing 03, from one or more insertion holes 03-1 into the circumferential wall, and cured.

Furthermore, Japanese Laid-Open Patent Application 10-318250 discloses a fluid dynamic pressure bearing in which a sleeve forming a bearing member is divided into a plurality of parts. The sleeve is constituted by stacking these parts in an axial direction, and it is disclosed that processing and manufacturing of V-shaped dynamic pressure grooves formed on the inner circumferential surface of the sleeve can be simplified.

### SUMMARY

The following problems can be seen in first and second conventional examples described above, in view of structure, and processing and manufacturing.

First, in order to increase a memory capacity, if the number of disks to be mounted is increased, a disk-mounting portion of a spindle motor has to be made longer, so the length of the spindle motor in the axial direction becomes long. Accordingly, the axial direction dimension L of the fluid dynamic pressure bearing also becomes long, and the thick portion dimension L2 of the sleeve 02 also becomes long. Therefore, it is difficult to process the inner circumferential surface of the thick portion of the sleeve 02 over the entire area of the dimension L2 with uniform high accuracy. In addition, as the inner diameter becomes smaller, the processing becomes so-called deep hole processing, in which manipulation and control of a machining tool or the like in a hole becomes difficult because there is a very small space in which to support and guide the tool even though the tool must be positioned deeply within the hole. Thus, the processing becomes more difficult, which creates a problem.

Furthermore, the micro gaps between both end surfaces of the thick portion of the sleeve 02 and the inner end surfaces of the thrust plates 05, 05 are important because they become the axial dynamic pressure generating portions, and a constant gap needs to be formed. However, in order to do so, the difference dimension (L1-L2) between the axial direction dimension L1 of the large-diameter portion of the fixed shaft 01 and the dimension L2 between both end surfaces of the thick portion of the sleeve 02 have to be constant. It is difficult to obtain this micro-dimension difference, for example, 6-8 μm in this example, through individual processing of the fixed shaft 01 and the sleeve 02, respectively. Even if the dimension is measured for each part, subtraction is performed, and appropriately dimensioned parts are selected and combined, productivity is poor. The more the production number increases, the more difficult it becomes to handle this problem.

Additionally, the end surfaces of the medium thickness portion of the sleeve 02 become surfaces that abut the seal rings 06. Simultaneously, these become references that determine the gap dimension between the seal rings 06 and the thrust plates 05, and this gap dimension is important because it controls the capillary seal function. This gap dimension is determined by the relationship with the difference dimension [L3−(L1+2L4)] (L4: thickness dimension of the thrust plate 05), so this difference dimension has to be constant. In order to do so, irregularities of the respective dimension L3, L1, L4 have to be precisely processed so that the difference dimension becomes constant. This is as difficult as obtaining the constant difference dimension (L1-L2) between the axial direction dimension L1 of the large-diameter portion of the fixed shaft 01 and the dimension L2 between both end surfaces of the thick portion of the sleeve 02 as described above.

Furthermore, when the dimension L2 between both end surfaces of the thick portion of the sleeve 02 becomes long, the processing of the through holes 07 becomes deep hole processing. The narrower the through holes 07 become, the more difficult the processing becomes.

As discussed above, Japanese Laid-Open Patent Application 10-318250 discloses a fluid dynamic pressure bearing in which a sleeve forming a bearing member is divided into a plurality of parts, and that processing and manufacturing of V-shaped dynamic pressure grooves formed on the inner circumferential surface of the sleeve can be simplified. However, this does not particularly relate to processing precision of the sleeve inner circumferential surface and the control of the axial direction dimension of the sleeve when the sleeve is lengthened, or to control of the bearing gap dimension of the radial or axial dynamic pressure generating portions based on the processing precision and axial direction dimension.

Thus, with conventional fluid dynamic pressure bearings, there are many problems in terms of structure, processing and manufacturing. There are issues to be resolved in terms of cost reduction and productivity.

The invention of this application addresses the above-mentioned problems of conventional fluid dynamic pressure bearings. This invention provides a fluid dynamic pressure bearing in which, even if the axial length of a spindle motor is made long to allow an increase in the number of information recording media mounted in order to increase the memory capacity of a memory device, and the axial lengths of a shaft member and a bearing member are thereby also made long, highly accurate processing of these elements can be easily performed, and highly accurate finishing of the radial dynamic pressure bearing portion, the axial dynamic pressure bearing portion, the capillary seal portion, etc. can be easily accomplished. The invention also provides a spindle motor and a recording disk drive device that are provided with the fluid dynamic pressure bearing.

In one aspect, the invention provides a fluid dynamic pressure bearing in which relative rotation occurs between a shaft member and a bearing member, via a radial dynamic pressure bearing portion and an axial dynamic pressure bearing portion. The shaft member has small-diameter portions on both ends, and a large-diameter portion between the small-diameter portions. Thrust plates are respectively engaged with the small-diameter portions. The bearing member includes a casing, a sleeve assembly body engaged with the casing, and seal rings that cover the thrust plates and are engaged respectively to open ends of the casing so as to seal the open ends. The sleeve assembly body includes at least two sleeve elements and a spacer sleeve element that is arranged coaxial to the sleeve elements so as to be sandwiched between the sleeve elements. A radial dynamic pressure generating groove is formed on either an outer circumferential surface of the large-diameter portion of the shaft or an inner circumferential surface of the sleeve element facing the outer circumferential surface via a micro gap. An axial dynamic pressure generating groove is formed on either an inner end surface of the thrust plate or an outer end surface of the sleeve element facing the inner end surface via a micro gap. Capillary seal portions are formed between the thrust plates and seal rings.

Because the bearing member has the above-described structure, a sleeve element having surfaces for the radial dynamic pressure generating portion and the axial dynamic pressure generating portion can be manufactured as one element of the sleeve assembly body. Furthermore, at least two such sleeve elements are provided. A spacer sleeve element is arranged coaxial to the two sleeve elements so as to be sandwiched between the two sleeve elements. The sleeve elements and spacer sleeve element constitute the sleeve assembly body.

Thus, the axial direction dimension of the sleeve elements can be reduced, so the processing of the inner circumferential surface becomes easy. Highly accurate finishing of the inner circumferential surface becomes easy, and in turn, highly accurate finishing of the radial dynamic pressure bearing portion faced by the inner circumferential surface becomes easy. Furthermore, by selecting sleeve elements with a standard dimension as the axial dimension, and accurately finishing the axial direction dimension of the spacer sleeve elements, a sleeve assembly body with a very accurately finished axial direction dimension can be obtained. It becomes easy to very accurately finish the axial dynamic pressure bearing portion formed by micro gaps determined by the difference dimension between the length dimension L1 between both thrust plates and the axial direction dimension L2 of the sleeve assembly body. By so doing, a fluid dynamic pressure bearing with very precise rotation can be obtained. In addition, standardization of parts become possible, so the cost of the fluid dynamic pressure bearing can be reduced, and mass production becomes easy.

Furthermore, when very accurately finishing the axial direction dimension of the spacer sleeve elements as explained earlier in order to accomplish highly accurate finishing of the axial dynamic pressure bearing portion, there are several methods of adjusting the finishing processing of the spacer sleeve elements. As a first method, the dimension L6 of the spacer sleeve element can be standardized, individual dimensions of a plurality of spacer sleeve elements can be recorded and stored, and a spacer sleeve element having an exact dimension L6 that can ensure the dimension L2 can be selected from stock based on the records and combined with the sleeve elements without a post-processing step. As a second method, finishing adjustment can be performed by storing spacer sleeve elements that have a standardized dimension with extra material in the dimension L6 for a post-processing step, and spacer sleeve elements randomly selected from stock can be individually post-processed to ensure the dimension L2. As a third method, when a new structure is demanded by a user, a spacer sleeve element with the requested shape and dimension can be newly manufactured to ensure the dimension L2, without standardizing and storing spacer sleeve elements.

Additionally, a plurality of adhesive insertion holes may be formed through a circumferential wall of the casing. Adhesive-receiving circumferential grooves that communicate with the adhesive insertion holes may be formed on an inner circumferential surface of the casing, and the adhesive insertion holes and the adhesive-receiving circumferential grooves may be arranged so as to substantially correspond to axial direction center positions of the sleeve elements and the spacer sleeve element constituting the sleeve assembly body.

By so doing, engagement to the casing of the sleeve elements and the spacer sleeve element can be performed by filling adhesive from the adhesive insertion holes into the adhesive-receiving circumferential grooves formed on the inner circumferential surface of the casing so as to be in fluid communication with the adhesive insertion holes, in a state in which the sleeve assembly body is inserted into the casing. The adhesive is spread over the entire circumference of the adhesive-receiving circumferential groove and is uniformly spread onto each element from the adhesive-receiving circumferential grooves, attaching these elements to the casing, so an airtight engagement state can be obtained. In addition, because adhesive can be inserted from the adhesive insertion holes formed in the circumferential wall of the casing, attachment of the adhesive to the lubricant insertion gap portion and other outer portions can be suppressed, and operability at the time of assembly can be improved.

Furthermore, a plurality of adhesive insertion holes may be formed through a circumferential wall of the casing. In outer circumferential surfaces of the sleeve elements and the spacer sleeve element constituting the sleeve assembly body, adhesive-receiving circumferential grooves may be formed which, in a state in which the sleeve assembly body is engaged to the casing, communicate with the adhesive insertion holes. The adhesive insertion holes and the adhesive-receiving circumferential grooves may be arranged so as to substantially correspond to axial direction center positions of the sleeve elements and the spacer sleeve element constituting the sleeve assembly body.

By so doing, engagement to the casing of the sleeve elements and the spacer sleeve element can be performed by filling adhesive from adhesive insertion holes into adhesive-receiving circumferential grooves formed in the respective outer circumferential surfaces of the sleeve elements and the spacer sleeve element so as to be in fluid communication with the adhesive insertion hole, in a state in which the sleeve assembly body is inserted into the casing. The adhesive is spread over the entire circumference of the adhesive-receiving circumferential groove and is uniformly spread onto each element from the adhesive-receiving circumferential grooves, attaching these elements to the casing, so an airtight engagement state can be obtained. In addition, because adhesive can be inserted from the adhesive insertion holes formed in the circumferential wall of the casing, attachment of the adhesive to the lubricant insertion gap portion and other outer portions can be suppressed, and operability at the time of assembly can be improved.

Furthermore, a viscosity of the adhesive may be selected according to the size of a gap at a portion at which the sleeve assembly body is engaged to the casing.

By so doing, adhesive can be sufficiently spread into the gap at the portion at which the sleeve assembly body engages with the casing, so a strong attachment of the sleeve elements and the spacer sleeve element to the casing becomes possible, and airtightness of the gap can be reliably ensured.

In addition, at least one through hole may be formed through the sleeve assembly body in an axial direction.

Thus, the amount of lubricant that can be stored can be increased, and leakage of lubricant can be suppressed by balancing dynamic pressure forces in the respective radial dynamic pressure portions and the respective axial dynamic pressure portions, arranged on both ends apart from each other.

Between the sleeve elements and the seal rings respectively arranged on both end portion sides of the sleeve assembly body, spacer rings may be inserted so as to surround the thrust plates via diameter direction micro gaps.

As a result, control of the dimension of the micro gaps formed between the thrust plates and the seal rings can be performed by very accurately adjusting, to a predetermined dimension, the axial direction dimension L7 of the spacer ring by a post-processing step at the time of assembly. Highly accurate finishing of the capillary seal portions formed between the thrust plates and the seal rings becomes easy. Thus, capillary seal portions with a constantly high sealing function can be obtained.

In addition, the spacer ring inserted between the sleeve element and the seal ring arranged on one end portion side of the sleeve assembly body may be formed integrally with the casing.

Thus, the number of parts can be reduced by one, and when the assembled body of the shaft member and the sleeve assembly body is engaged and assembled to the casing, assembly becomes possible by abutting the sleeve assembly body to the integrally formed spacer ring of the casing in the axial direction, and the assembly of the assembly body of the shaft member and the sleeve assembly body to the casing becomes easy.

In another aspect, the invention provides a fluid dynamic pressure bearing in which relative rotation occurs between a shaft member and a bearing member, via a radial dynamic pressure bearing portion and an axial dynamic pressure bearing portion. The shaft member has small-diameter portions on both ends, and a large-diameter portion between the small-diameter portions. Thrust plates are respectively engaged with the small-diameter portions. The bearing member includes a casing, a sleeve assembly body engaged with the casing, and seal rings that cover the thrust plates and are engaged respectively to open ends of the casing so as to seal the open ends. The sleeve assembly body is constituted by at least two sleeve elements. A radial dynamic pressure generating groove is formed on either an outer circumferential surface of the large-diameter portion of the shaft or an inner circumferential surface of the sleeve element facing the outer circumferential surface via a micro gap. An axial dynamic pressure generating groove is formed on either an inner end surface of the thrust plate or an outer end surface of the sleeve element facing the inner end surface via a micro gap. Capillary seal portions are formed between the thrust plates and seal rings.

Because the bearing member has the above-described structure, a sleeve element having surfaces for the radial dynamic pressure generating portion and the axial dynamic pressure generating portion can be manufactured as one element of the sleeve assembly body. Furthermore, at least two such sleeve elements are provided to constitute the sleeve assembly body.

Thus, the axial direction dimension of the sleeve elements can be reduced, so the processing of the inner circumferential surface becomes easy. Highly accurate finishing of the inner circumferential surface becomes easy, and in turn, highly accurate finishing of the radial dynamic pressure bearing portions faced by the inner circumferential surface becomes easy. Furthermore, if this type of sleeve element is standardized, fluid dynamic pressure bearings can be manufactured with standardized parts. Thus, the cost of the fluid dynamic pressure bearing can be reduced, and mass production becomes easy.

In another aspect, the invention provides a spindle motor provided with any of the fluid dynamic pressure bearings described above, and including: a stator fixed to a base; and a rotor that is constituted by a hub, which forms a rotation element engaged with the casing, and a permanent magnet that is directly, or indirectly via a yoke, engaged with an outer circumferential tubular portion of the hub and that generates a rotating magnetic field in cooperation with the stator. The rotor is rotatably arranged with respect to the base, and the fluid dynamic pressure bearing supports rotation of the rotor.

In addition, in another aspect, the invention provides a spindle motor provided with any of the fluid dynamic pressure bearings described above, and including: a stator fixed to a base; a rotor that is constituted by a hub, which forms a rotation element engaged with one end portion of the shaft member; and a permanent magnet that is directly, or indirectly via a yoke, engaged with an outer circumferential tubular portion of the hub and that generates a rotating magnetic field in cooperation with the stator. The rotor is rotatably arranged with respect to the base, and the fluid dynamic pressure bearing supports rotation of the rotor.

Because the spindle motors have a structure as described above, parts can be standardized, and a spindle motor with high reliability can be mass-produced at a lower cost using a low-cost fluid dynamic pressure bearing that can be easily mass-produced, and which has high rotation accuracy.

In another aspect, the invention provides a recording disk drive device provided with a spindle motor as described above, and including: a recording disk; and a recording head that writes and/or reads information with respect to the recording disk. The spindle motor rotatingly drives the recording disk.

Because the recording disk drive device is thus constituted, it is highly reliable and can be mass-produced at a low cost.

Thus, according to exemplary embodiments of a fluid dynamic pressure bearing of the invention of this application, the axial direction dimension of the sleeve elements can be reduced, so the processing of the inner circumferential surface becomes easy. Highly accurate finishing of the inner circumferential surface becomes easy, and in turn, highly accurate finishing of the radial dynamic pressure bearing portion faced by the inner circumferential surface becomes easy. Furthermore, by selecting sleeve elements with a standard dimension as the axial dimension, and accurately finishing the axial direction dimension of the spacer sleeve elements, a sleeve assembly body with a very accurately finished axial direction dimension can be obtained. It becomes easy to very accurately finish the axial dynamic pressure bearing portion formed by micro gaps determined by the difference between the length dimension L1 between both thrust plates and the axial direction dimension L2 of the sleeve assembly body. By so doing, a fluid dynamic pressure bearing with very precise rotation can be obtained. In addition, standardization of parts become possible, so the cost of the fluid dynamic pressure bearing can be reduced, and mass production becomes easy.

Furthermore, engagement to the casing of the sleeve elements and the spacer sleeve element can be performed by filling adhesive from an adhesive insertion holes into adhesive-receiving circumferential grooves, in a state in which the sleeve assembly body is inserted into the casing. The adhesive is spread over the entire circumference of the adhesive-receiving circumferential grooves and is uniformly spread onto each element from the adhesive-receiving circumferential grooves, attaching these elements to the casing, so an airtight engagement state can be obtained. In addition, because adhesive can be inserted from the adhesive insertion holes formed in the circumferential wall of the casing, attachment of the adhesive to the lubricant insertion gap portion and other outer portions can be suppressed, and operability at the time of assembly can be improved.

Additionally, the viscosity of the adhesive may be selected according to the size of the gap at the portion at which the sleeve assembly body engages the casing. Therefore, adhesive can be sufficiently spread into the gap at the portion at which the sleeve assembly body engages with the casing, so a strong attachment of the sleeve elements and the spacer sleeve element to the casing becomes possible, and airtightness of the gap can be reliably ensured.

A very significant point of at least one aspect of the invention is that when the sleeve elements are standardized and stored, and the length dimension L1 between both thrust plates of the shaft is determined, sleeve elements with a predetermined dimension may be randomly selected from among the stock of the standardized sleeve elements. The dimension L6 needed for the spacer sleeve element, which is the easiest element to process, is instantly determined from already-known dimensions such as the axial direction dimensions L5a, L5b, etc. of the selected sleeve elements. In turn, the axial direction dimension L2 of the sleeve assembly body is ensured with high accuracy.

That is, in a fluid dynamic pressure bearing that needs to be constituted by parts with a high overall accuracy, by having a structure in which desired assembly accuracy is ensured for the spacer sleeve element, which can be most easily processed in terms of accuracy and time, even when a large number of fluid dynamic pressure bearings with high accuracy is manufactured, it is possible to complete products speedily. At the same time, even when the dimension L2 is changed, it is possible to handle the request speedily.

Furthermore, as described above, according to the spindle motor and the recording disk drive device of the invention of this application, by using a low-cost fluid dynamic pressure bearing in which parts can be standardized, mass production can be easily performed, and rotation accuracy is high, a spindle motor and a recording disk drive device with high reliability can be mass-produced at a low cost.

These and other objects, advantages and features of the invention are described in or apparent from the following description of exemplary embodiments.

### BRIEF DESCRIPTION OF THE DRAWINGS

Exemplary embodiments are described with references to the accompanying drawings, in which like numerals represent like parts, and in which:

FIG. 1 is a vertical cross-sectional view of a fluid dynamic pressure bearing of a first embodiment (embodiment 1) of the invention of this application;

FIG. 2 is a vertical cross-sectional view of a fluid dynamic pressure bearing of a second embodiment (embodiment 2) of the invention of this application;

FIG. 3 is a vertical cross-sectional view of a fluid dynamic pressure bearing of a third embodiment (embodiment 3) of the invention of this application;

FIG. 4 is a vertical cross-sectional view of a fluid dynamic pressure bearing of a fourth embodiment (embodiment 4) of the invention of this application;

FIG. 5 is a vertical cross-sectional view of a spindle motor of a fifth embodiment (embodiment 5) of the invention of this application;

FIG. 6 is a vertical cross-sectional view of a hard disk drive device of a sixth embodiment (embodiment 6) of the invention of this application;

FIG. 7 is a diagram showing a conventional example; and

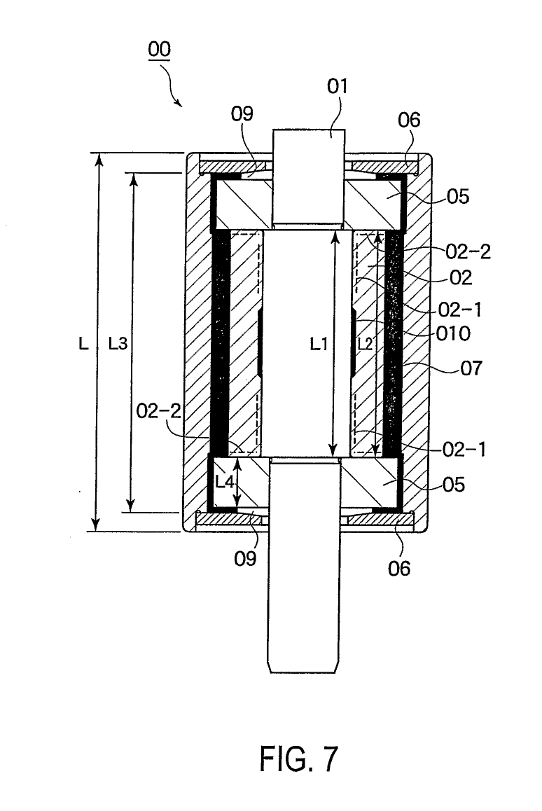

FIG. 8 is a diagram showing another conventional example.

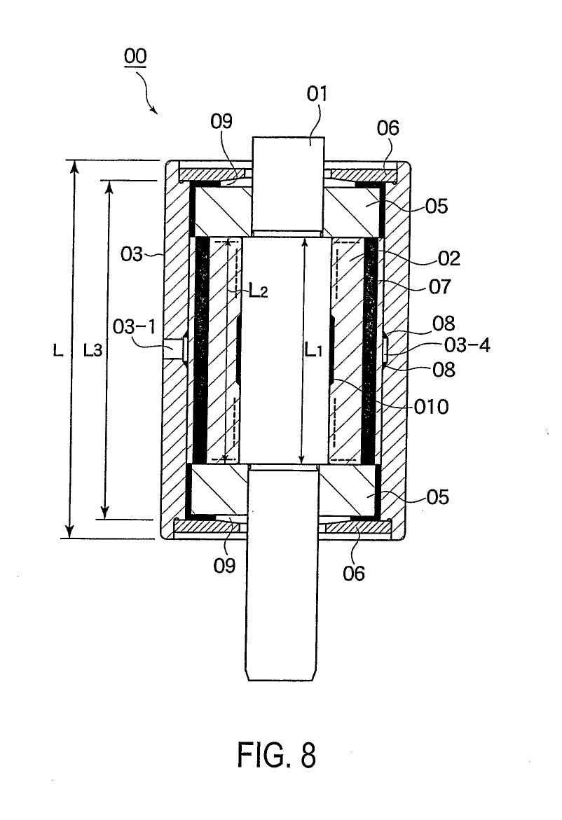

### DETAILED DESCRIPTION OF EMBODIMENTS

The following explains a first embodiment (embodiment 1) of the invention of this application.

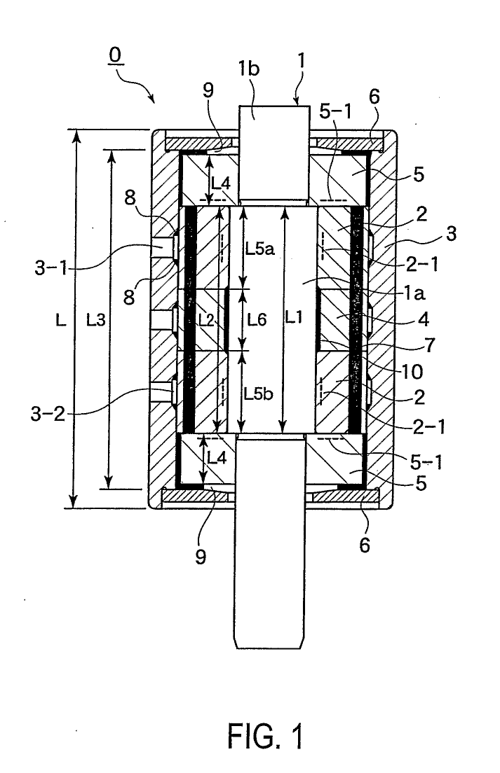

FIG. 1 is a vertical cross-sectional view of a fluid dynamic pressure bearing of the first embodiment. In this figure, in a fluid dynamic pressure bearing 0 of the first embodiment, a shaft member (no number assigned) is formed in which thrust plates 5,5 are engaged to small-diameter portions 1b of a fixed shaft 1 that has a large-diameter portion 1a in the intermediate portion and small-diameter portions 1b on both end portions. Furthermore, in FIG. 1, a bearing member (no number assigned) is formed in which a spacer sleeve element 4 is sandwiched between a pair of upper and lower sleeve elements 2, 2, on the same axis as the sleeve elements 2, 2. The pair of sleeve elements 2, 2 and the spacer sleeve element 4 are engaged to the inner circumferential surface of a casing 3. Hereafter, the assembly body that is formed of the pair of upper and lower sleeve elements 2, 2 and the spacer sleeve element 4 that is arranged so as to be sandwiched between the pair of sleeve elements 2, 2 on the same axis as the pair of upper and lower sleeve elements 2, 2 is called a “sleeve assembly body.”

On the inner circumferential surfaces of the sleeve elements 2, radial dynamic pressure generating grooves 2-1 are formed. On the inner end surfaces (surface facing the sleeve elements 2) of the thrust plates 5, axial dynamic pressure generating grooves 5-1 are formed. The grooves 2-1 and 5-1 may have a shape currently known in the art in the context of dynamic pressure generating grooves, or any later-developed shape.

The bearing member is supported by the shaft member via micro gap formed between the outer circumferential surface of the large-diameter portion 1a of the fixed shaft 1 and the respective inner circumferential surfaces of the sleeve elements 2, 2 and the spacer sleeve element 4, and via micro gaps formed between the inner end surfaces of the thrust plates 5, 5 and the outer end surfaces of the sleeve element 2, 2. Lubricant 10 is filled in these micro gaps. The inner circumferential surfaces of the upper and lower end portions of the casing 3 of the bearing member are enlarged in diameter, forming step portions. Seal rings 6 are respectively engaged with these step portions, sealing the bearing end portions.

The micro gaps formed between the outer circumferential surface of the large-diameter portion 1a of the fixed shaft 1 and the respective inner circumferential surfaces of the sleeve elements 2, 2 and the spacer sleeve element 4, and the micro gaps formed between the inner end surfaces of the thrust plates 5, 5 and the outer end surfaces of the sleeve elements 2, 2 are further connected to micro gaps formed between the casing 3 and the outer circumferential surface of the thrust plates 5, and micro gaps (which form the later-described capillary seal portions 9) formed between the inner end surfaces of the seal rings 6 and the outer end surfaces of the thrust plates 5. These micro gaps are all in fluid communication with each other. Furthermore, the lubricant 10 is filled in the micro gaps that are all in fluid communication with each other, and a continuous oil film of the lubricant 10 is provided in the micro gaps. The continuous oil film is in a substantially cylindrical shape and has a uniquely shaped cross section, open at both ends, and both end portions of the continuous oil film protrude inward toward the fixed shaft 1.

A plurality of through holes 7 are formed in the sleeve elements 2, 2 and the spacer sleeve element 4 so as to pass through the sleeve elements 2, 2 and the spacer sleeve element 4 in the axial direction. The through holes 7 are connected to a micro gap formed between the inner end surface of the upper thrust plate 5 and the outer end surface of the upper sleeve element 2 and a micro gap formed between the inner end surface of the lower thrust plate 5 and the outer end surface of the lower sleeve element 2. Therefore, the above-mentioned micro gaps that are in fluid communication with each other are also in fluid communication with the through holes 7. The through holes 7 are useful in order to increase the stored amount of the lubricant 10, and to balance dynamic pressure forces in the respective radial dynamic pressure bearing portions and the respective axial dynamic pressure bearing portions that are spaced apart from each other at both ends and suppress the lubricant 10 from leaking out due to local abnormal pressure increases in these locations.

The dimensions of the respective sleeve elements 2 are determined within a range in which highly accurate processing precision is obtained in mass production processing, including the processing of the portions corresponding to the through holes 7. By using standardized dimensions, parts can be made to be common. The spacer sleeve element 4 is provided with portions corresponding to the through holes 7. The inner diameter dimension of the spacer sleeve element 4 is larger than the inner diameter dimension of the sleeve elements 2, and the outer diameter dimension of the spacer sleeve element 4 is the same as the outer diameter dimension of the sleeve elements 2. The length dimension of the spacer sleeve element 4 may be set so that extra material is present for a post-processing step at the time of assembly.

On the circumferential wall of the casing 3, adhesive insertion holes 3-1 are formed at positions respectively substantially corresponding to the centers, in the axial direction, of the engaged sleeve elements 2, 2 and spacer sleeve element 4. On the inner circumferential surface of the casing 3 at these positions, adhesive-receiving circumferential grooves 3-2 are formed, preferably having a width larger than the diameter of the insertion holes 3-1. Adhesive 8 is injected into the circumferential grooves 3-2 from the insertion holes 3-1, and the upper and lower sleeve elements 2, 2 and the spacer sleeve element 4 are engaged to the casing 3 by the adhesive.

The inner end surfaces of the seal rings 6 engaged to the stepped portions of the upper and lower end portions of the casing 3 form cross-sectionally wedge-shaped micro gaps with respect to the outer end surfaces of the flat thrust plates 5, with a taper that tapers outward as it approaches the center. The end portions of the continuous oil film of the lubricant 10 enter into and are contained within these micro gaps, and a reservoir for the lubricant 10 (oil reservoir) is formed therein. The lubricant 10 contained in this oil reservoir forms a liquid surface (meniscus) by surface tension, and is constantly drawn into the continuous micro gaps by capillarity. Therefore, the lubricant 10 is suppressed from leaking to the outside via the gaps between the fixed shaft 1 and the center openings of the seal rings 6, and the lubricant 10 is sealed. Thus, capillary seal portions 9 for the lubricant 10 are formed in the cross-sectionally wedge-shaped micro gap portions.

Therefore, when the bearing member is rotated, the bearing member is floatingly supported in the radial direction and the axial direction and is rotated in a non-contact manner with respect to the bearing member, due to radial dynamic pressure forces generated within the lubricant 10 by the radial dynamic pressure generating grooves 2-1 formed in the sleeve elements 2 and axial dynamic pressure forces generated within the lubricant 10 by the axial dynamic pressure generating grooves 5-1 formed in the thrust plates 5.

In the first embodiment, the micro gap dimension between the inner end surface of the thrust plates 5 and the outer end surface of the sleeve elements 2 is ensured as follows. Sleeve elements 2 having an already-known dimension (standard dimension) are randomly selected from stock, and the spacer sleeve element 4 is likewise randomly selected from stock. The necessary micro gap dimension is ensured by finishing processing adjustment of the length dimension L6 of the spacer sleeve element 4, with reference to the length dimension L1 of the large-diameter portion la of the fixed shaft 1, according to the following equation.
Necessary micro gap dimension=[L1−L2]=[L1−(L5a+L5b)−L6]

Here, L5a and L5b are the axial length dimensions of the upper and lower sleeve elements 2, 2, respectively. These may be the same or different.

Furthermore, there are several possible methods of finishing processing adjustment of the spacer sleeve element 4. As a first method, the dimension L6 of the spacer sleeve element 4 is standardized, individual dimensions of a plurality of spacer sleeve elements are recorded and stored, and a spacer sleeve element 4 having an exact dimension L6 that can sufficiently ensure the dimension L2, within a predetermined tolerance, is selected from the stock based on the records. In this method, the spacer sleeve element can be combined with the sleeve elements 2 without a post-processing step. As a second method, spacer sleeve elements 4 are provided with a standard dimension with some extra material in the dimension L6 for a post-processing step. A plurality of such spacer sleeve elements are stored, and a spacer sleeve element 4 randomly selected from stock can be individually finish-adjusted with a post-processing step so as to sufficiently ensure the dimension L2. As a third method, when a new structure is demanded by a user, a spacer sleeve element 4 can be manufactured with a new shape and dimension to meet the demand, and made to ensure the dimension L2. This method does not require standardizing the spacer sleeve elements 4 and storing them in stock.

When the sleeve elements 2 are randomly selected from the stock, sleeve elements 2 having an already-known inner diameter dimension that ensures an appropriate radial micro gap with respect to the outer diameter dimension of the large-diameter portion 1a of the fixed shaft 1 are selected from stock and engaged to the large-diameter portion 1a of the fixed shaft 1.

As the micro gap dimension between the inner end surface of the thrust plates 5 and the outer end surface of the sleeve elements 2 is thus ensured, even if the length dimension L1 becomes longer, both sleeve elements 2, 2 use a standard dimension as their length dimension, and only the intermediate spacer sleeve element 4 uses a larger length dimension L6; thus, it is possible to easily handle the situation.

The engagement of the spacer sleeve element 4 and the sleeve elements 2 to the casing 3 is performed by injecting the adhesive 8 through the adhesive insertion holes 3-1 formed in the circumferential wall of the casing 3, at positions substantially corresponding to the respective axial center positions of the sleeve elements 2 and the spacer sleeve element 4. The adhesive 8 flows into the adhesive-receiving circumferential grooves 3-2, which are formed in the inner circumferential surface of the casing 3 at positions corresponding to the insertion hole positions, in a state in which the sleeve assembly body (formed of sleeve elements 2, 2 and the spacer sleeve element 4) is engaged to the casing 3. The adhesive 8 injected through the insertion holes 3-1 is received by the circumferential grooves 3-2, fills the entire circumference of the circumferential grooves 3-2, uniformly spreads out to the periphery of the circumferential grooves 3-2, attaches the sleeve elements 2 and the spacer sleeve element 4 to the casing 3, and airtightly engages the sleeve elements 2 and the spacer sleeve element 4 to the casing 3.

Furthermore, in this case, the viscosity of the adhesive 8 is selected depending on the size of the gap at the portion at which the sleeve assembly body engages the casing 3. By so doing, the adhesive 8 sufficiently spreads into the gap at the portion at which the sleeve assembly body engages the casing, so airtightness of the gap can be reliably ensured along with strong adhesion to the casing 3 of the sleeve elements 2 and the spacer sleeve element 4. By injecting the adhesive 8 through the insertion holes 3-1 of the casing 3, adhesion of the adhesive 8 to other outside portions and the gap portions to be filled by the lubricant is suppressed, and operability at the time of assembly of the fluid dynamic pressure bearing is improved.

Furthermore, the sleeve elements 2, including the portions corresponding to the through holes 7, are also made to have shape dimensions having high precision and mass-producibility, and are made as components intended as structural elements of the fluid dynamic pressure bearing 0. The sleeve elements 2 are stocked with already-known dimension accuracy, and selection and combination can be appropriately performed at the time of assembly; thus, the effect of reducing the number of assembly parts can also be improved.

The following explains a second embodiment (embodiment 2) of the invention of this application.

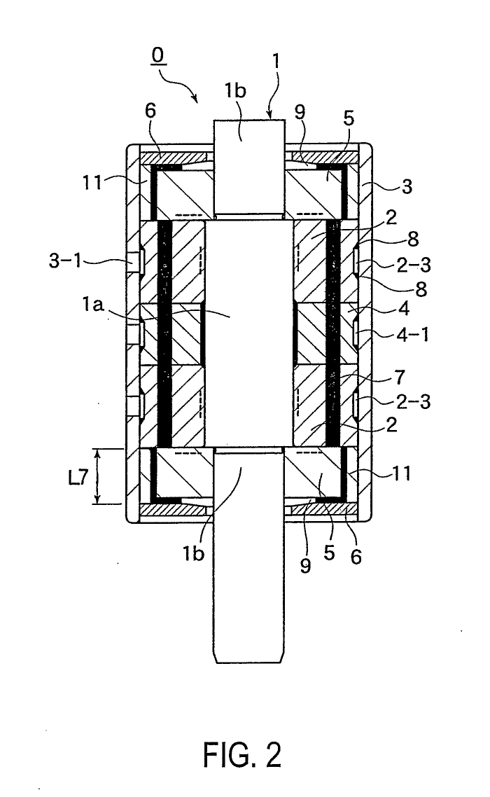

FIG. 2 is a vertical cross-sectional view of a fluid dynamic pressure bearing of the second embodiment of this invention. With respect to the fluid dynamic pressure bearing 0 of the second embodiment, the structures of the radial dynamic pressure generating portion and the axial dynamic pressure generating portion are basically the same as described in the first embodiment. A difference between the first and second embodiments is that, in the second embodiment, the inner circumferential surface of the casing 3 having the adhesive insertion holes 3-1 is made into a straight shape, and does not have adhesive-receiving circumferential grooves formed therein. Instead, adhesive-receiving circumferential grooves 2-3, 4-1 are formed in the outer circumferential surfaces of the sleeve elements 2, 2 and the spacer sleeve element 4, which are engaged inside the casing 3. The adhesive 8 is injected through the insertion holes 3-1, received by the circumferential grooves 2-3, 4-1, and spreads over the entire circumference. The adhesive is uniformly spread to the periphery of the circumferential grooves 2-3, 4-1, and the sleeve elements 2, 2 and the spacer sleeve element 4 are attached to the casing 3 and are airtightly engaged to the casing 3.

Furthermore, there is another difference between the first and second embodiments. That is, spacer rings 11 are mounted between the sleeve elements 2 and the seal rings 6 so as to surround the periphery of the thrust plates 5 via diameter direction micro gaps, and the seal rings 6 are engaged to respective end portion inner circumferential surfaces of the casing 3. Furthermore, the casing 3 is made to have an appropriate thinness to a degree in which manufacturing can be performed by press processing.

Because the second embodiment is thus constituted, the manufacturing of the casing 3 can be done by press processing or extrusion processing, and manufacturing of the casing 3 becomes easy. Furthermore, the adhesive-receiving circumferential grooves 2-3, 4-1 are formed on the outer circumferential surfaces of the sleeve elements 2 and the spacer sleeve element 4, so the processing is easier than processing that forms circumferential grooves on the inner circumferential surface of the casing 3.

Furthermore, because the spacer rings 11 are used, highly accurate finishing adjustment of the axial direction dimension L7 of the spacer rings 11 can be done, to a predetermined dimension, by a post-processing step at the time of assembly. Thus, accurate control of the length dimension L3 between surfaces of the upper and lower seal rings 6, 6 that abut the spacer rings 11 can become easy, and highly accurate finishing of the capillary seal portion becomes easy. By so doing, capillary seal portions with an extremely high sealing function can be obtained.

The following explains a third embodiment (embodiment 3) of the invention of this application.

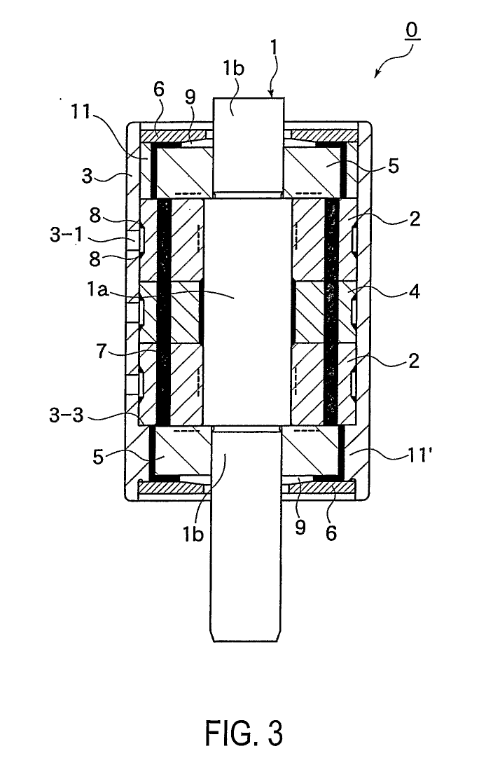

FIG. 3 is a vertical cross-sectional view of a fluid dynamic pressure bearing of the third embodiment of this invention. With respect to the fluid dynamic pressure bearing 0 of the third embodiment, the structures of the radial dynamic pressure generating portion and the axial dynamic pressure generating portion are basically the same as described in the first embodiment. A difference between the third embodiment and the first and the second embodiments is that the lower end side spacer ring 11 of the casing 3 of the second embodiment is formed integrally with the casing 3. Specifically, an inward protrusion 11′ corresponding to a spacer ring is formed on the casing 3.

By so doing, when the assembly body of the shaft member and the sleeve assembly body is engaged and assembled to the casing 3, this assembly body can be assembled to the casing 3 by abutting the outer end surface of the lower sleeve element 2 to the step portion 3-3 above the spacer-ring-corresponding inner protrusion 11′ of the casing 3 from above, in the axial direction. Assembly to the casing 3 of the assembly body of the shaft member and the sleeve assembly body becomes easy.

The following explains a fourth embodiment (embodiment 4) of the invention of this application.

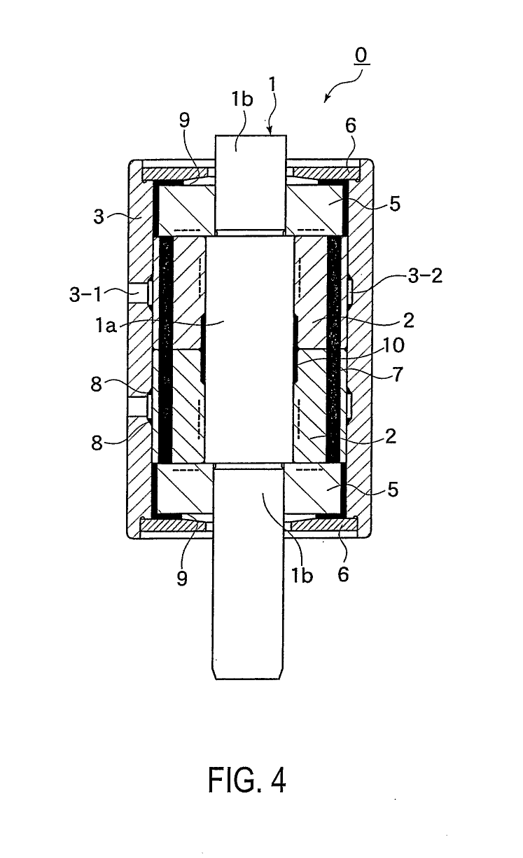

FIG. 4 is a vertical cross-sectional view of a fluid dynamic pressure bearing of the fourth embodiment of this invention. With respect to the fluid dynamic pressure bearing 0 of the fourth embodiment, compared to the first embodiment, there is a difference that the spacer sleeve element 4 of the first embodiment is not used, and two sleeve elements 2, 2 formed in a standard dimension are used so as to abut against each other. Because of this difference, two adhesive insertion holes 3-1 formed on the circumferential wall of the casing 3 and two adhesive-receiving circumferential grooves 3-2 formed on the inner circumferential surface of the casing 3 are formed to positionally correspond with the two sleeve elements 2.

Because the fourth embodiment is thus constituted, a post-processing step of the spacer sleeve element 4 is not needed, the formation of the fluid dynamic pressure bearing by standard parts is further promoted, and the manufacturing becomes easy.

The following explains a fifth embodiment (embodiment 5) of the invention of this application.

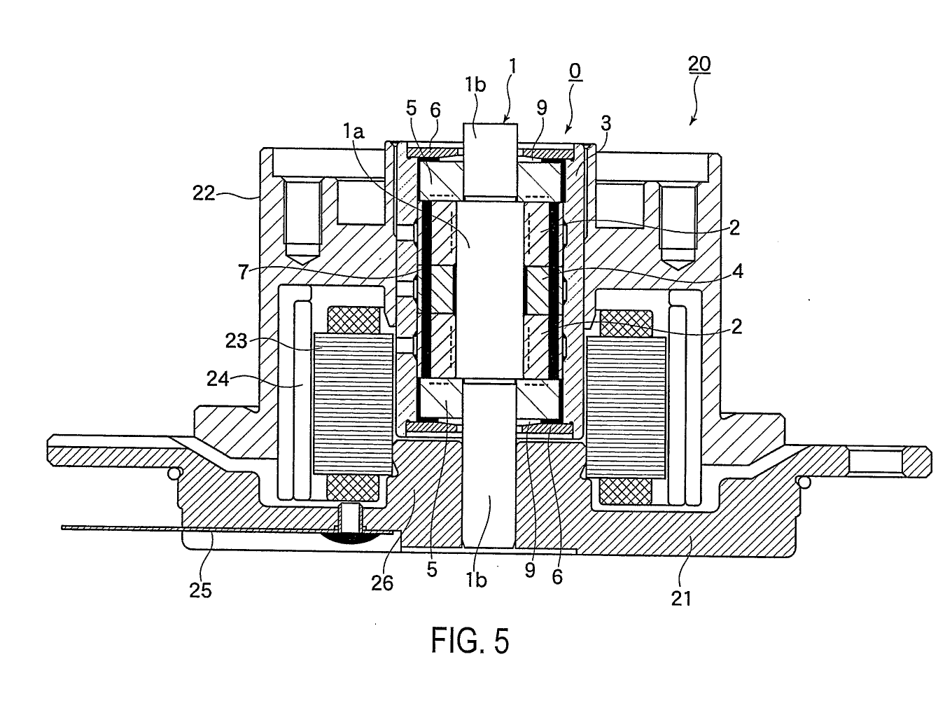

FIG. 5 is a vertical cross-sectional view of a spindle motor to which the fluid dynamic pressure bearing 0 of the first embodiment is applied. In this figure, a spindle motor 20 forms a fixed-shaft type spindle motor in which one small diameter portion 1b of the shaft 1 of the fluid dynamic pressure bearing 0 is engaged with a hole formed through a center boss portion 26 of a base 21. A hub 22 formed of, for example, a non-magnetic material such as aluminum alloy is engaged with an outer circumferential surface of the casing 3 of the fluid dynamic pressure bearing 0 and can be rotated integrally with the bearing member of the fluid dynamic pressure bearing 0, which has the casing 3 as one structural element. On the outer circumferential surface of the hub 22, of which the axial direction length is made slightly longer, undepicted information recording media, such as magnetic disks, optical disks, etc., are mounted in layers.

A stator 23 in which coils are wound around a stator core is engaged with the outer circumferential surface of the center boss portion 26 of the base 21. Spaced slightly from the stator 23 in the diameter direction, permanent magnets 24 engaged with a shield yoke are arranged in a circumferential direction so as to surround the stator 23, and are mounted to the inner circumferential surface of the lower half portion of the circumferential wall of the outer circumferential tubular portion of the hub 22. A flexible wiring substrate 25 maybe fixed to the lower surface of the base 21, and as a control electric current is supplied to the stator 23 from an output terminal of the wiring substrate 25, a rotor formed of the permanent magnets 24, the hub 22, and the yoke begins to rotate with respect to the stator 23. When a non-magnetic material such as aluminum alloy is used for the hub 22, as in this embodiment, a ring-shaped yoke formed of a magnetic material should be inserted between the hub 22 and the permanent magnets 24 in order to constitute a magnetic circuit. Furthermore, if the hub 22 is formed of a magnetic material such as martensite or ferrite stainless alloy, the hub 22 may be directly mounted to the permanent magnets 24, and a yoke need not be used.

The spindle motor 20 of embodiment 5 is thus constituted. Therefore, by using a fluid dynamic pressure bearing in which parts can be standardized, the cost can be reduced, mass production can be easily performed, and rotation accuracy is high, a spindle motor with high reliability can be mass-produced at a low cost.

The following explains a sixth embodiment (embodiment 6) of the invention of this application.

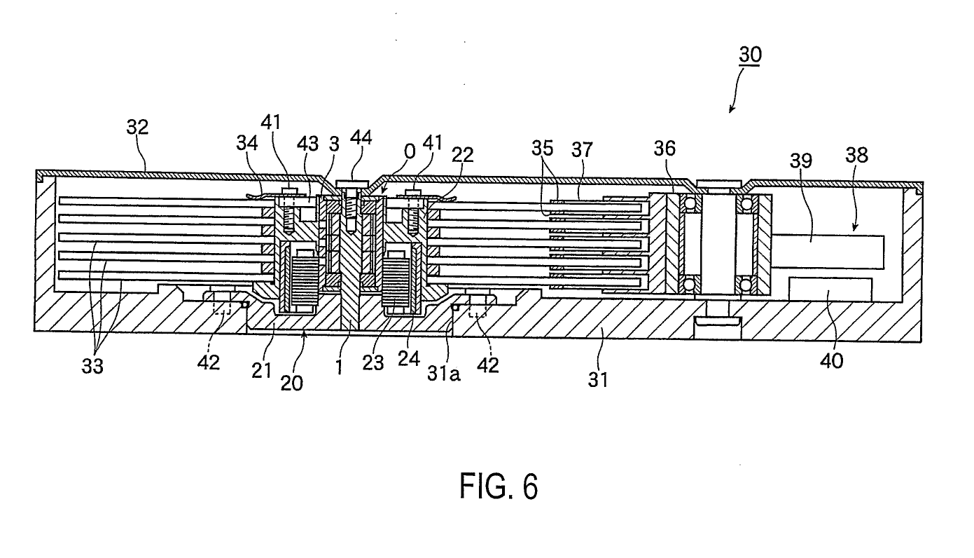

FIG. 6 is a vertical cross-sectional view of a hard disk drive device of embodiment 6 provided with the spindle motor 20 (see FIG. 5) of the above-mentioned embodiment 5. As shown in FIG. 6, the hard disk drive device 30 of embodiment 6 is provided with a housing 31 that accommodates the spindle motor 20 of embodiment 5, and a cover member 32 that seals the space within the housing 31 and forms a clean space with extremely little dust or the like. The housing 31 and the cover member 32 form a casing of the hard disk drive device 30.

The tubular portion of the base 21 is engaged with a fixing hole 31a of the housing 31, and fixing screws 42 are inserted through a plurality of through-holes arranged in the base 21 and tightened to the housing 31, thus fixing the spindle motor 20 to the housing 31. Thus, a main body portion including the stator 23 of the spindle motor 20 and a rotor (including the hub 22, the permanent magnets 24, and yoke) is accommodated within the casing of the hard disk drive device 30. As a modified example, a structure is also acceptable in which a single-part housing is formed in which the base 21 is integral with the housing 31, and the housing is used as a mounting portion for the fluid dynamic pressure bearing 0 and the stator 23 of the spindle motor 20, and as part of the casing of the hard disk drive device 30.

Five hard disks (recording disks) 33 are mounted in layers on the outer circumferential surface of the outer circumferential tubular portion of the hub 22. By, for example, engaging mounting screws 41 with a plurality of axial direction screw holes formed in the top surface of the hub 22, and fixing a clamp member 34 to the hub 22 via a seat plate 43, the hard disks 33 are fixed to the hub 22. Thus, the hard disks 33 are rotated integrally with the hub 22. In the embodiment of FIG. 6, five hard disks 33 are mounted on the hub 22, but the number of hard disks 33 is not limited to this.

The hard disk drive device 30 is provided with magnetic heads (recording heads) 35 that write and/or read information with respect to the hard disks 33, an arm 36 that supports the magnetic heads 35 via suspensions 37, and a voice coil motor 38 that moves the magnetic heads 35 and the arm 36 to a predetermined position. The voice coil motor 38 is provided with a coil 39 and a magnet 40 arranged facing the coil 39.

The magnetic heads 35 are mounted to the tip end portion of the suspensions 37 fixed to the arm 36, which is rotatably supported at an appropriate location within the housing 31. A pair of magnetic heads 35 is arranged above and below the hard disk 33 so as to sandwich the hard disk 33, and can write and/or read information with respect to the both surfaces of the hard disk 33. In the embodiment of FIG. 6, five hard disks 33 are used, so five pairs of magnetic heads 35 are arranged.

The hard disk drive device 30 of embodiment 6 is thus constituted. Therefore, by providing the highly reliable spindle motor 20, which can be mass-produced at low cost, a recording disk drive device with high reliability can be mass-produced at a low cost.

Furthermore, in embodiment 6, the spindle motor 20 is applied to the hard disk drive device 30, but the example of the spindle motor 20 is not limited to this. For example, if the magnetic heads 35 are replaced with optical heads, and the hard disk drive device 30 is replaced by a recording disk drive device that drives a recording disk such as a CD or DVD, the spindle motor can be applied to the recording disk drive device. In this case as well, the same effects as mentioned above can be obtained.

The invention of this application is not limited to the above-mentioned embodiment. Various changes, substitutes and improvements are possible within the spirit and scope of the invention.

For example, in the above-mentioned embodiments, the shaft side is stationary and fixed. However, the invention is not limited to this. The shaft side can be rotated. In such a case, the hub 22 is engaged with one end portion of the shaft (shaft member 1). Furthermore, in use, the orientation of the shaft can be vertical or horizontal. In addition, the radial dynamic pressure generating grooves 2-1 and the axial dynamic pressure generating grooves 5-1 can also be formed on the other opposing surface. Additionally, the number of sleeve elements 2 can be further increased.

1. A fluid dynamic pressure bearing comprising:
a shaft member, including (i) a shaft having a large-diameter portion on an intermediate portion of the shaft and having small-diameter portions on both end portions of the shaft and (ii) thrust plates respectively engaged with the small diameter portions; and
a bearing member, relative rotation occurring between the shaft member and the bearing member via a radial dynamic pressure bearing portion and an axial dynamic pressure bearing portion, wherein
the bearing member comprises a casing, a sleeve assembly body engaged to the casing, and seal rings that cover the thrust plates and are respectively engaged to open end portions of the casing, so as to at least partially seal the open end portions of the casing;
the sleeve assembly body comprises (i) at least two sleeve elements and (ii) at least a spacer sleeve element that is coaxial to the sleeve elements and between the sleeve elements;
a radial dynamic pressure generating groove is formed on either an outer circumferential surface of the large-diameter portion of the shaft or an inner circumferential surface of the sleeve element facing the outer circumferential surface via a micro gap;
an axial dynamic pressure generating groove is formed on either an inner end surface of each thrust plate or an outer end surface of each sleeve element facing the inner end surface via a micro gap; and
capillary seal portions are formed between the thrust plates and seal rings.

2. The fluid dynamic pressure bearing as set forth in claim 1, wherein:
a plurality of adhesive insertion holes are formed through a circumferential wall of the casing;
adhesive-receiving circumferential grooves are formed on an inner circumferential surface of the casing in fluid communication with the adhesive insertion holes; and
the adhesive insertion holes and the adhesive-receiving circumferential grooves are arranged so as to substantially correspond to respective axial direction center positions of the sleeve elements and the spacer sleeve element constituting the sleeve assembly body.

3. The fluid dynamic pressure bearing as set forth in claim 1, wherein:
a plurality of adhesive insertion holes are formed through a circumferential wall of the casing;
on respective outer circumferential surfaces of the sleeve elements and the spacer sleeve element constituting the sleeve assembly body, adhesive-receiving circumferential grooves are formed which, in a state in which the sleeve assembly body is engaged with the casing, fluidly communicate with the adhesive insertion holes; and
the adhesive insertion holes and the adhesive-receiving circumferential grooves are arranged so as to substantially correspond to respective axial direction center positions of the sleeve elements and the spacer sleeve element constituting the sleeve assembly body.

4. The fluid dynamic pressure bearing as set forth in claim 2, wherein a viscosity of the adhesive is selected according to a size of a gap at a portion at which the sleeve assembly body is engaged to the casing.

5. The fluid dynamic pressure bearing as set forth in claim 1, wherein at least one through hole is formed through the sleeve assembly body in an axial direction.

6. The fluid dynamic pressure bearing as set forth in claim 1, wherein between the sleeve elements and the seal rings respectively arranged on both end portion sides of the sleeve assembly body, spacer rings are inserted so as to surround the thrust plates via diameter-direction micro gaps.

7. The fluid dynamic pressure bearing as set forth in claim 6, wherein the spacer ring inserted between the sleeve element and the seal ring at one end portion side of the sleeve assembly body is formed integrally with the casing.

8. A fluid dynamic pressure bearing comprising:
a shaft member, including (i) a shaft having a large-diameter portion on an intermediate portion of the shaft and having small-diameter portions on both end portions of the shaft and (ii) thrust plates respectively engaged with the small diameter portions; and
a bearing member, relative rotation occurring between the shaft member and the bearing member via a radial dynamic pressure bearing portion and an axial dynamic pressure bearing portion, wherein
the bearing member comprises a casing, a sleeve assembly body engaged to the casing, and seal rings that cover the thrust plates and are respectively engaged to open end portions of the casing, so as to at least partially seal the open end portions of the casing;
the sleeve assembly body comprises at least two sleeve elements;
a radial dynamic pressure generating groove is formed on either an outer circumferential surface of the large-diameter portion of the shaft or an inner circumferential surface of the sleeve element facing the outer circumferential surface via a micro gap;
an axial dynamic pressure generating groove is formed on either an inner end surface of each thrust plate or an outer end surface of each sleeve element facing the inner end surface via a micro gap; and
capillary seal portions are formed between the thrust plates and seal rings.

9. A spindle motor provided with the fluid dynamic pressure bearing as set forth in claim 1, comprising:
a stator fixed to a base;
a rotor that is constituted by a hub, which forms a rotation element engaged with the casing, and a permanent magnet that is directly, or indirectly via a yoke, engaged with an outer circumferential tubular portion of the hub and that generates a rotating magnetic field in cooperation with the stator, the rotor being rotatably arranged with respect to the base;
wherein the fluid dynamic pressure bearing supports rotation of the rotor.

10. A spindle motor provided with the fluid dynamic pressure bearing as set forth in claim 1, comprising:
a stator fixed to a base;
a rotor that is constituted by a hub, which forms a rotation element engaged with one end portion of the shaft member, and a permanent magnet that is directly, or indirectly via a yoke, engaged with an outer circumferential tubular portion of the hub and that generates a rotating magnetic field in cooperation with the stator, the rotor being rotatably arranged with respect to the base;
wherein the fluid dynamic pressure bearing supports rotation of the rotor.

11. A recording disk drive device provided with the spindle motor as set forth in claim 9, comprising:
a recording disk; and
a recording head that writes and/or reads information with respect to the recording disk,
wherein the spindle motor rotatingly drives the recording disk.
